(19) United States
(12) Patent Application Publication
(10) Pub. No.: US 2026/0099701 A1
(43) Pub. Date: Apr. 9, 2026

(54) DENDRITIC COMPUTATION FOR NEURAL NETWORKS

(71) Applicant: National Technology & Engineering Solutions of Sandia, LLC, Albuquerque, NM (US)

(72) Inventors: Suma George Cardwell, Albuquerque, NM (US); Mark Plagge, Poway, CA (US); Frances S. Chance, Albuquerque, NM (US)

(21) Appl. No.: 18/905,532

(22) Filed: Oct. 3, 2024

(51) Int. Cl. G06N 3/049

(52) U.S. Cl. CPC G06N 3/049

(57) ABSTRACT

A dendrite computing network is provided. The network comprises a dendrite comprising a number of dendrite compartments in a sequential chain, wherein each dendrite compartment has a respective state with an electrical current value for a given time step, and wherein each dendrite compartment saves electrical current values computed in previous time steps. Each dendrite compartment receives a respective external electrical input current with a respective input weight. Each dendrite compartment has a respective leak weight. A temporal modifier determines how quickly each dendrite compartment responds to input signals, and a spatial signal transmission constant that controls communication between dendrite compartments. The temporal modifier and spatial signal transmission constant are used to create a kernel that iterates through a specified number of time steps to compute a new electrical current value in the state of each dendrite compartment.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to artificial neural networks and more specifically to using dendritic computations to reduce computational costs in neural networks.

### 2. Background

As deep learning and large-scale neural networks are rapidly transforming the space of computing, the energy and compute cost of these networks are still bound by the limitations of hardware performance scaling. To help solve this problem there is ongoing research into developing computationally efficient deep learning techniques, including reducing the total number of MultiplyAccumulate (MAC) operations, leveraging low-energy acceleration hardware devices, and other techniques. Spiking Neural Network (SNN) s are a category of brain-inspired machine learning algorithms that leverage event-driven binary-communication connectivity to address low-energy data transfer, one of the largest energy consumption areas in deep learning. In spite of offering one to two orders of magnitude improvement in energy efficiency, these networks generally use simple Leaky Integrate-and-Fire (LIF) neuron models which have limited expressivity. These SNNs using LIF neurons tend to perform worse than state of the art deep learning models when comparing raw accuracy rates.

SNNs are capable of solving one of the largest energy consumption areas in deep learning: data transfer costs. Current deep networks have highly optimized designs for computation, and now the transmission of data (from storage to system memory, system memory to GPU memory, GPU memory to local caches, etc.), dominates the energy landscape. SNNs have two major benefits in this area in that they are event-driven and they generally communicate using low-cost binary signals.

Therefore, it would be desirable to have a method and apparatus that take into account at least some of the issues discussed above, as well as other possible issues.

### SUMMARY

An illustrative embodiment provides a dendrite computing network comprising a dendrite comprising a number of dendrite compartments in a sequential chain, wherein each dendrite compartment has a respective state with an electrical current value for a given time step, and wherein each dendrite compartment saves electrical current values computed in previous time steps. Each dendrite compartment receives a respective external electrical input current with a respective input weight. Each dendrite compartment has a respective leak weight. A temporal modifier determines how quickly each dendrite compartment responds to input signals, and a spatial signal transmission constant that controls communication between dendrite compartments. The temporal modifier and spatial signal transmission constant are used to create a kernel that iterates through a specified number of time steps to compute a new electrical current value in the state of each dendrite compartment.

Another illustrative embodiment provides a dendrite-enabled spiking neural network comprising an input layer and a hidden layer comprising a number of dendrite neuron chains. Each dendrite neuron chain comprises a dendrite having a number of dendrite compartments in a sequential chain. An output layer receives output signals from the last dendrite compartments in the sequential chains and combines the output signals into a single spiking neuron soma.

Another illustrative embodiment provides dendrite-enabled residual network comprising a convolutional encoder and a dendrite pooling layer comprising a number of dendrite neuron chains. Each dendrite neuron chain comprises a dendrite having a number of dendrite compartments in a sequential chain and a spiking neuron soma that receives output from the last dendrite compartment in the sequential chain. A fully connected classification head receives output from the dendrite pooling layer.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a diagram of a passive resistor-capacitor circuit diagram modeling a neuromorphic dendrite in accordance with an illustrative embodiment;

FIG. 2 depicts a diagram of a passive transistor circuit diagram modeling a neuromorphic dendrite in accordance with an illustrative embodiment;

FIG. 3 depicts a diagram of a three-compartment dendrite network in accordance with an illustrative embodiment;

FIG. 4A depicts a graph a response curve of a three-dendrite neuron for a t value of 1.0 in accordance with an illustrative embodiment;

FIG. 4B depicts a graph a response curve of a three-dendrite neuron for a t value of 5.0 in accordance with an illustrative embodiment;

FIG. 5 depicts a diagram of a single-neuron coincidence detection network in accordance with an illustrative embodiment;

FIG. 6 depicts a number of graphs illustrating differences in spike time for a coincidence detection network for different values of t in accordance with an illustrative embodiment;

FIG. 7 depicts a diagram of a fully connected spiking neural network;

FIG. 8 depicts a diagram of a dendritic network architecture in accordance with an illustrative embodiment;

FIG. 9 depicts a table comparing the performance of LIF-only spiking networks against a dendrite-enabled spiking network;

FIG. 10A depicts the operation of a dendrite model in conjunction with a convolutional neural network in accordance with an illustrative embodiment; and

FIG. 10B depicts the operation of a dendrite model in conjunction with a convolutional neural network in accordance with an illustrative embodiment.

### DETAILED DESCRIPTION

The illustrative embodiments recognize and take into account that in biological systems, dendrites are a structure that enable processing of inputs en route to the soma (cell body), providing much of the neuron's overall computational capabilities. Dendrites perform computations that include non-linear filtering, coincidence detection, directional selectivity, and amplification of synaptic inputs as key “compute-on-wire” properties of the “dendritic toolkit.” Implementing dendrites in hardware and utilizing them as key computational elements in our algorithms will provide increased computational capabilities while increasing overall efficiency. Thus, dendrites implemented in hardware offer an approach to maintaining the efficiency of a simple LIF based Spinking Neural Networks (SNNs) while matching the machine learning performance of traditional Artificial Neural Networks (ANNs). The primary challenges to realizing dendrite-enabled neural networks include a lack of tools focused on large-scale machine learning as well as a lack of hardware support that leverages the energy efficiency of these networks.

As a way to enhance the expressivity of SNNs, there is significant ongoing research on the potential of integrating dendrites within SNNs. Dendrites provide non-linear computation, compute-on-wire capabilities in hardware, and increase the expressivity of the spiking neuron model. These properties of dendrites present a potential way to maintain the efficiency of a simple LIF-based SNN while matching the machine learning performance of traditional ANNs. The primary challenges facing dendritic neural networks include a lack of tools focused on large-scale machine learning as well as a lack of hardware support that leverages the energy efficiency of these networks.

Increasing adoption and usage of SNNs with dendritic components requires a rich set of tools and components that machine learning domain experts can use to build out and evaluate large-scale networks of dendrite-enabled neurons. Of the existing SNN deep-learning tools available, deep learning models with dendrite support are not large-scale enough, do not support machine learning libraries, do not have hardware support, etc. Our work builds on Py-Torch with snnTorch to create a deep-learning-oriented hardware-based dendritic library. Below we describe the implementation of a multi-compartment dendrite library, demonstrate how dendrites can reduce the number of LIF neurons required to learn functions and reduce the number of signals passed over the SNN, and discuss future applications of the dendrite-enabled LIF neuron. We envision that this library may provide a touchstone for further development of deep SNNs, which could justify new development of high-efficiency dendrite enabled SNN hardware designs in the future.

It is well established that biological dendrites have significant computational capabilities, and may, in fact, be the site of the majority of the compute of the neuron, with spikes providing energy-efficient long-distance communication. In machine learning applications, dendrite structures have been shown to provide increased performance for a variety of tasks. With SNNs in particular, dendritic computation gives the spiking neuron a wide and dynamic range of compute capabilities.

Current SNN frameworks in machine learning generally leverage a simplified LIF model. This is often a choice based on performance, as the LIF model is simpler to calculate. Increasing the biological fidelity of neuron simulations dramatically increases the amount of computation required in software, which precludes these models from use in large-scale machine learning tasks. Tools such as SpikingJelly scale to extremely large model sizes but lack the explicit hardware-based dendritic modeling of more detailed models.

One of the major drivers of the current machine learning revolution is a confluence of software tooling, general purpose graphics card compute hardware, and a strong link between the GPU hardware and the computations required by modern neural network models. The genesis of modern deep learning, AlexNet, would not have been feasible without the “pseudo codesign” of AI algorithms and GPU hardware capabilities. Explicit dendrite modeling that is accessible for machine learning development is a missing link for design of next generation machine learning hardware.

Our work addresses the lack of machine learning oriented dendritic SNN tools available today. Current large-scale SNNs use simplified neuron models which are much more computationally viable than the more complex SNN models. By adding dendritic computation to SNNs, our toolkit should allow for more expressive large-scale SNNs which in turn we hope will drive forward a growth of high-efficiency neural network designs. In large-scale SNNs, extremely simplified neuron models are used, as the more complex neuron models are not nearly as GPU and CPU efficient as M-P style neural network computations.

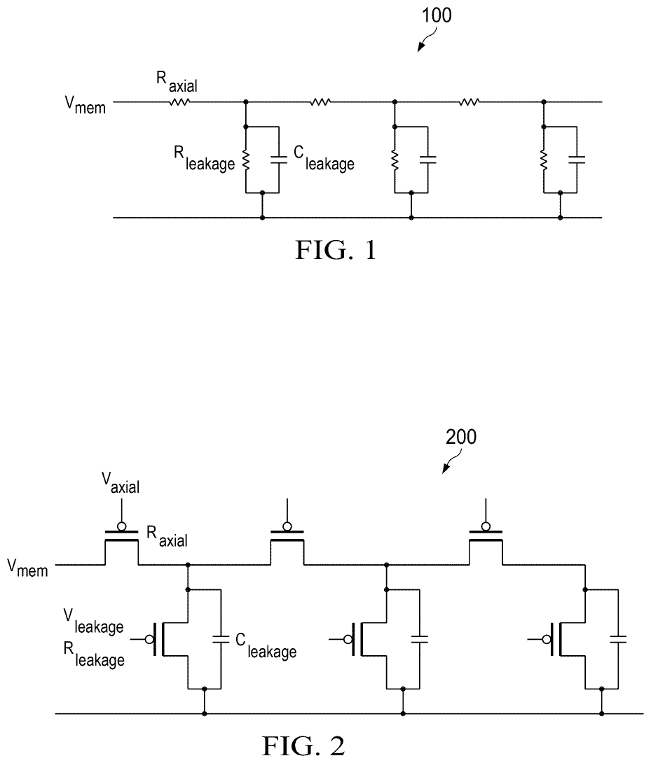

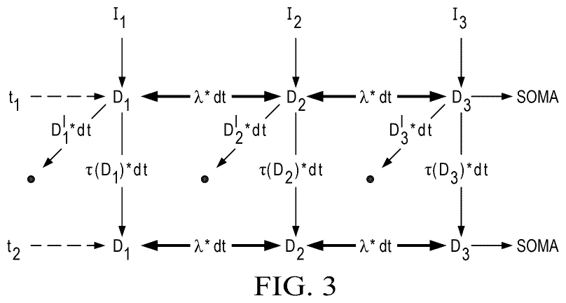

FIGS. 1 and 2 illustrate a linear passive cable model that represents a dendritic cable. A resistor-capacitor (RC) circuit such as that shown in FIG. 1 captures the ‘passive’ properties of a biological dendrite. In this passive RC circuit 100, Vₘₑₘ is the membrane potential, Rₐₓᵢₐₗ is the axial resistance and R_{leakage}, C_{leakage} are the leakage resistance and capacitance respectively. This RC circuit 100, in turn, can be modeled using CMOS transistors operating in a linear region as shown in FIG. 2. In CMOS circuit 200, transistors used to model a passive cable in silicon where Vₐₓᵢₐₗ is the gate voltage for the axial transistor and Vₗₑₐₖ is the gate voltage for the leakage transistor.

As seen in FIG. 2, two transistors can represent a single stage in this dendrite. This lightweight dendrite component, consisting of two transistors, provides a low energy and high-density dendrite hardware implementation, paving the way for highly dense dendritic hardware networks. This implementation of the dendritic cable using CMOS transistors uses sub-threshold voltage values which provide an analog response along the cable.

Dendrites have been modeled in silicon in analog and mixed signal CMOS chips. These in silico neuromorphic systems not only model synaptic memory along the dendrite cable, but also model key ion-channel properties to capture dynamics observed in dendrites. There is also interest in leveraging beyond-CMOS dendrites to replicate dendrite-like density and connectivity. These devices provide energy-efficient computation through this recreation of dendritic structures. This hardware structure provides computation on the wire, as the computation and data transfer occur on the same circuit.

In terms of machine learning, the addition of dendrites have been shown to provide dynamic behavior as well as increase the computational power of a spiking neuron. Dendrites in a machine learning network have been leveraged to provide filtering of input signals, logical operations, amplification of signals, coincidence detection, and other dynamic computational operations, with some research showing a combination of dendrites and synaptic plasticity can recreate error propagation. These applications show a wide potential in the realm of machine learning applications for spiking networks. Adding dendrites to a spiking neural network, in this domain, adds parameters to the network and can be conceptually seen as adding layers to a non-spiking neural network. These properties of dendrites increase the expressivity of point neuron models and show interesting properties that have the potential to dramatically improve the performance of spiking neural networks.

There is a great deal of research examining spiking networks in deep learning applications, with numerous applications showing the potential of SNNs in machine learning. Spiking networks currently have the potential to provide energy and latency improvements compared to traditional deep neural networks, and as such much research is focused on improving accuracy while providing improved latency or reduced energy use, or both.

Using dendrites to inform or enhance SNN design has resulted in improvements in network performance, online learning and feature updates, and an implementation of novel activation functions that enables a single neuron to classify the XOR logical function. Further research has also shown that dendritic SNNs can help improve online training, keyword detection, along with several other categories of applications. LIF neurons have been profiled at 20 pJ per synaptic operation and moving from LIF to multi-compartment neurons has been shown to increase efficiency 10× on SpiNNaker 2, a digital neuromorphic chip implemented in 22 nm FDSOI. Analog implementations for larger CMOS nodes have been shown to be very efficient with 10 pJ/event (Analog 350 nm subthreshold), 2.8 pJ (28 nm DYNAP-SEL). Emerging devices are capable of ≈10 fJ per synaptic operation.

There is a wide variety of biological neuron modeling tools, SNN modeling tools, and other software frameworks available and in development. These range from highly detailed simulations of biological processes, “middle-ground” simulations which allow larger scale network design, and simplified models which treat dendrites as wires and follow simple neuron rules. There is, of course, some overlap between these categories, but most SNN tools fall within this spectrum.

Some software libraries attempt to bridge the detailed simulation techniques with large scale simulations. Dendrify, for example, provides dendrite models with a high degree of biological accuracy while supporting larger scale simulations. Based on the Brian 2 simulation system, Dendrify extends Brian 2's neuron models to include a variety of dendrite behaviors. This tool, however, does not have native support for surrogate gradient descent nor does it support extremely large SNN models, as the underlying Brian 2 system uses numerical solvers for ODEs in the backend. Other tools, such as Norse, provide simplified multi-compartment models for modeling synaptic plasticity, synaptic recurrence, and other dynamic components of a spiking neuron. These tools do provide some dendritic benefits, but they do not allow explicit dendrite design within the framework. Our model and tool are based on a hardware implementation of a dendrite cable as described in, simplified for reasonable performance, and coupled with snnTorch to provide surrogate gradient descent learning methods.

Our deep-learning focused dendrite library leverages a linear cable model based on a hardware dendrite model to potentially provide high-efficiency computation. Our model uses PyTorch and provides a dendrite building block for SNN development. To emulate the binary spike signaling found in SNNs and enable learning, we leveraged snnTorch a machine-learning spiking neuron library. This library allows users to create SNNs from within PyTorch, allowing for larger scale machine learning oriented SNN model development. Dendrite behavior is modeled according to a machine learning library that maps between the network and hardware devices.

In our library, dendrites are modeled as stateful components which save the previous dendrite current values computed from the previous time-step. We implement the temporal and spatial current spread as a set of iterative computations which compute the change in voltages based on a time value. Each dendrite has a definable temporal modifier, a spatial value, a set of weights, and a configurable exponential kernel. The temporal component, τ, represents the signal delay across dendrite compartments that determines how quickly each dendrite compartment responds to input signals, while λ represents the spatial signal transmission constant that controls communication between dendrite compartments. These values are used to create a kernel that iterates through the number of time-steps specified to compute the new current in the dendrite states. This is a simplification of the more complex active dendrite model. This simplification enables larger-scale computation and is compatible with the surrogate gradient functions provided in the snnTorch library.

Our dendrites use input data in a vector of M×B×I size, where M is time, B is batch size, and/is the input size (which can be n-dimensional). Our dendrite network implements a resolution parameter, dt, which represents the number of “ticks” that occur between between M, and a t value, which represents the time in-between each step, T. If dt is one, then one iteration is computed for each M. Smaller values of dt increase the number of iterations over the dendrite during a forward pass. If the dendrite models are used in a traditional PyTorch network that does not consider state or temporal changes of layers over time, the T value enables the dendrites to expand each input tensor into steps. For SNNTorch or temporal-aware networks, the T value can be set to one, and the input tensor's time dimension will provide the needed temporal space.

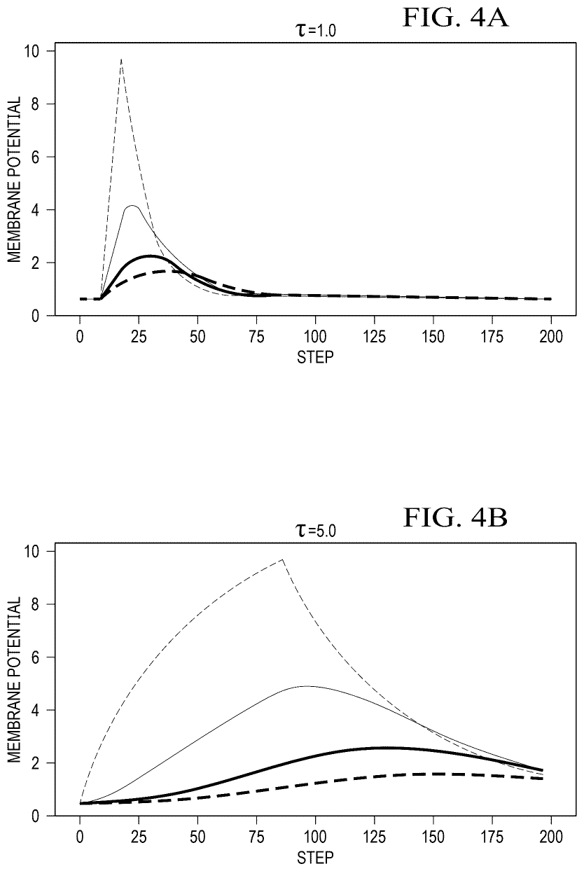

FIG. 3 depicts a diagram of a three-compartment dendrite network in accordance with an illustrative embodiment. From the initial cable model, with I₁, I₂, and I₃ as inputs to dendrite compartments D₁, D₂, D₃, respectively, Dₗ as per-dendrite compartment leak, τ as the per dendrite compartment connection time constant (delay across compartments), and λ as the dendrite space constant, we construct a simplified dendritic computational step. Each compartment D₁, D₂, D₃ of the dendrite has an input and a “drain” or leak. Each input, I, is multiplied by respective input weight, w. Therefore, each compartment has a respective input with a respective weight applied to it, D_{I,w}. The leak is a learnable parameter for each compartment. For each iteration on the dendrite compartments, the internal value (state, current) of each compartment has a respective leak weight, l, subtracted from it. Therefore, each compartment, D, is increased by I*w and decreased by l.

Taking a multi-step ODE system of equations as a starting point, rather than solving the ODE for a set number of time steps and resolution, we iterate over each dendrite pair during the forward pass, computing the change in dendrite voltage. Before the dendritic operations, the external inputs to each dendrite compartment are modified by a weight value, such that Id=Id*Dw. These inputs are applied to the dendrite compartments, and the current in each dendrite compartment is computed using this iterative method. FIG. 3 shows this method on a three-compartment network over two time steps, which would represent a dt of 0.5. To simplify the equation, we define:

$${I}_{d} = {Input}_{d} * τ * d t$$

where I_{d} is the input to dendrite compartment d. If there are N compartments in a chain, the first compartment's computation at step t is computed as

$${D}_{1}^{t} = ( {D}_{1}^{t - 1} + {I}_{1} ) + ( {D}_{2}^{t - 1} * λ * d t )$$

Compartments not on the edge of the chain, i.e. compartment numbers in (1,N] are computed as

$${D}_{n}^{t} = ( {D}_{n}^{t - 1} + {I}_{n} ) + ( {D}_{n - 1}^{t - 1} * λ * d t ) + ( {D}_{n + 1}^{t - 1} * λ * d t )$$

and the final dendrite compartment's new value is computed as

$${D}_{N}^{t} = ( {D}_{N}^{t - 1} + {I}_{N} ) + ( {D}_{N - 1}^{t - 1} * λ * d t )$$

for the number of intermediate steps requested. Therefore, each compartment receives external input as well as time delayed inputs from its neighboring compartments. The output of the final dendrite compartment in the chain is sent to an integrate and fire neuron implementation from SNNTorch which represents the soma. This neuron acts as the soma of the overall dendrite neuron. As an alternative, the output value of the last dendrite can be sent to the next module or layer in the network directly, for more advanced or non-spiking network designs.

The end result of this computation is that the dendrite layer behaves as hybrid of a pooling layer, an activation layer, and as a nonlinear transformation layer. This dendrite chain modulates the soma's output behavior, creating a precomputation unit.

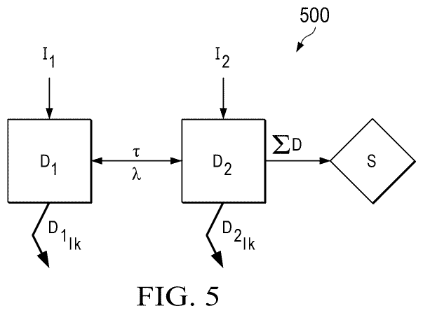

In our work, dendritic parameters available are learnable, and represent the underlying circuit design this network is based on. In FIGS. 4A and 4B, we show a three-compartment dendrite network's response to changing parameters, with each network receiving an input value of 1.0, from steps 1 to 20. In FIG. 4A, λ and τ are configured for a rapid current response. In FIG. 4B, the 2 value is increased to demonstrate a much slower dendrite response.

Spiking networks have been shown to provide coincidence detection mechanisms through relaying synaptic inputs to spike times. A simple form of coincidence detection in spiking networks simply take an input spike from a connected neuron, j, and spike if the time between js spikes are within a set time value. If j spikes within this boundary, then the output neuron will send a signal.

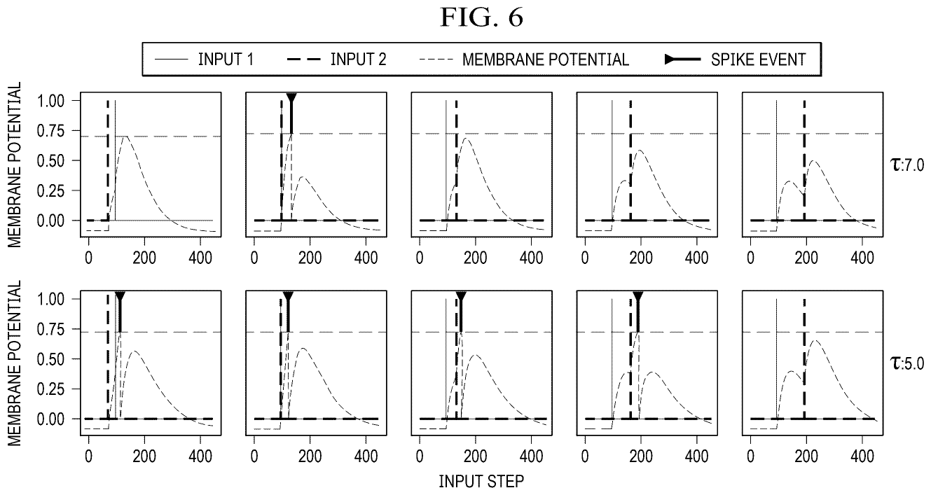

To demonstrate dendrite computation, we implemented a coincidence detection network, shown in FIG. 5, which used a single LIF neuron with our dendrite model. The two dendrite compartments, D₁ and D₂, receive respective inputs from I₁ and I₂. Each dendrite compartment has a leak value, Dₙ_{ᵢₖ}, which reduces the dendritic value after each input. Dendrite compartment D₂ outputs a value to the soma, S.

Leveraging dendrites to implement coincidence detection provides more computational features when compared with a simple SNN implementation. Each neuron may have one or more dendritic inputs, each with their own decay, τ, and λ values. By setting these values appropriately, a dendritic LIF neuron is able to differentiate between inputs over a target time frame. While LIF neurons are also capable of this computation, dendrites provide more per-input parameters for more flexibility along with compute-on-wire hardware acceleration as previously discussed.

We configured a two-compartment dendritic network with an Integrate-and-Fire (IF) soma as a coincidence detection network. In this demonstration, we wanted the output neuron to fire if a signal is received by both input neurons within one time-step. In FIG. 4, we show the response rates of this network for a set of inputs. With this configuration, any combination of inputs will enable a spike, as long as the inputs occur within one dendritic time-step. The relationship between the output spike and the dendritic inputs is tuned through adjusting the 2, t, and dendritic weight values. The time interval over which coincidence is detected is tuned by adjusting the dendrite leak values. FIG. 5 shows the logical design of the dendritic coincidence detection network.

Coincidence detection network 500 provides learned parameters for the construction of CMOS circuit 200 in FIG. 2, and conversely, CMOS circuit 200 provides hardware constraints for coincidence detection network 500.

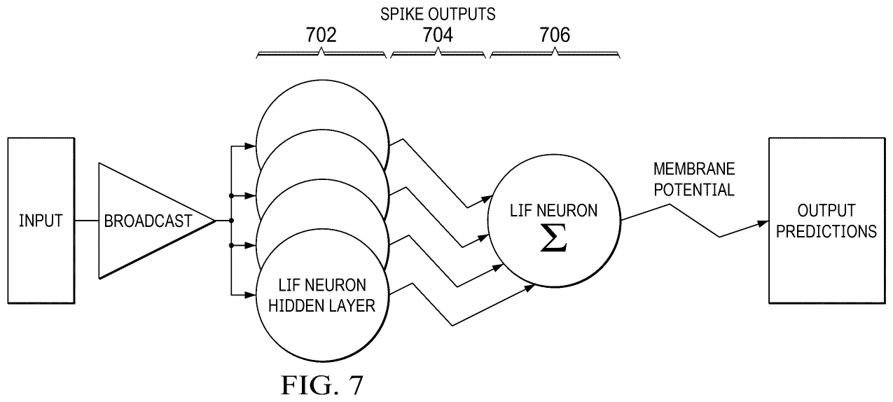

The soma response to various input spike intervals, illustrated in FIG. 6, shows that small changes in t create large shifts in how the network responds to the two inputs. Increasing t increases the responsiveness of the neuron, which reduces the maximum time between inputs for an output spike to appear. This single neuron coincidence detector example showcases both the added computational capabilities to a LIF neuron as well as how small changes in the hyper-parameters or learned parameters of the dendrite can make large changes in the overall network behavior.

To demonstrate the capabilities of dendrite-enabled LIF neurons, we implemented a simple fully connected neural network using LIF neurons and a similar network using dendrite-enabled neurons. We configured the input layer to broadcast the signal to a hidden layer, consisting of 256 LIF neurons, 16 LIF neurons, or 16 dendrite-enabled LIF neurons. This layer communicates to the output neuron, which sends the membrane potential as output of the network. This network is an implementation of spiking network linear regression method, which learns the objective by minimizing the mean square error.

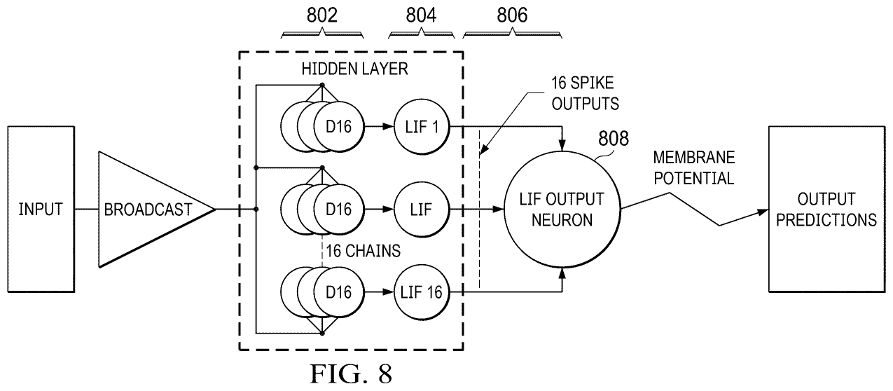

The SNN is based on a design used as an exemplar model from the snnTorch library. FIG. 7 depicts a diagram of a simple fully connected spiking neural network. We train this example network with either 16 or 256 LIF neurons in the fully connected hidden layer 702, which results in either 16 or 256 spikes 704, respectively, sent to the output layer 706 for each input data sample.

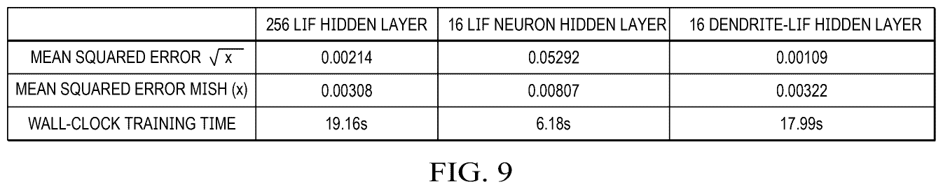

The dendritic version, shown in FIG. 8, replaces the 256 neuron layer with 16 dendrite neuron chains 804, each with 16 dendritic compartment inputs 802. This configuration effectively takes the 256 output value broadcast from the previous layer and reduces the output to 16 signals. We chose this particular configuration so that there are still 256 computational operations taking place, but the total information sent to the summary neuron is only 16 spikes wide. In dendritic hardware, the 256 dendrite computations would be computed as the signals are propagated through the network which is leveraging the compute-on-wire capabilities of such hardware. Furthermore, this reduces the total signals that would be sent “off-neuron”, which would reduce a network on chip communication cost. The final layer is a single dendritic neuron 808 with a 16 dendrite input chain 806 which combines the hidden layer signals into the single soma. This neuron acts as a non-linear sum of inputs from the previous layer. Finally, the output of this neuron is the membrane potential, rather than the spike train. This follows the linear regression example from the original work. The 16 neuron SNN is the same model as the 256 neuron model, but with far fewer neurons in the hidden layer.

In this example, our target functions are f(x)=\sqrt{x} and f(x)=Mish(x), which are a pair of simple nonlinear functions. Mish is a self-regularized activation function, defined as f(x)=x*tanh(Softplus(x)). Each input x of training data consisted of 1,000 random samples from the range X, where X={x∈R|x>0|x<1} for \sqrt{(x)}, and X={x∈R|>−3|x≤1} for the mish function. As snnTorch and dendrites expect temporal data, the dataset shape became 10×1×1, with 10 copies of x in each batch.

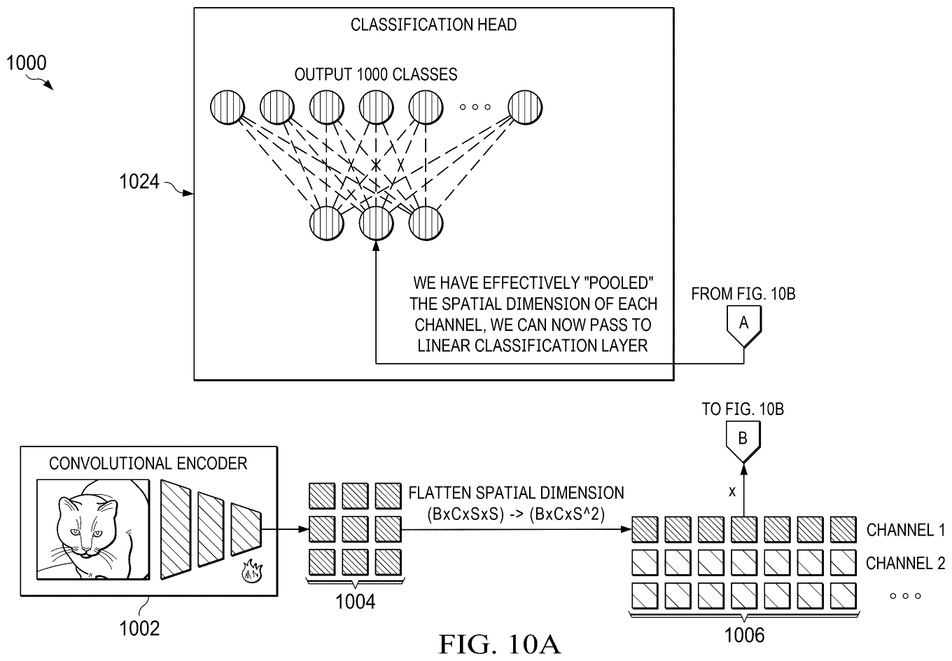

Neuron weights and dendrite parameters were randomly initialized for the test. In the case of the spiking network, the neurons were set to learn weight, threshold, and reset values. The dendritic neurons were set to learn λ, τ, leaks, and the threshold value. We trained each network for 100 iterations over the sampled x values with a batch size of one. The results of these tests are shown in FIG. 9.

Training was done on a workstation computer, running an Intel Xeon E5-1660 V4 with an Nvidia Titan Xp GPU. The 256 neuron SNN took a total of 17.99 s training with the dendritic SNN, and 19.16 s with the 256 sized hidden layer SNN. The primary reason for this performance is the iteration needed during training. The snnTorch framework uses internal state changes during training to simulate time-steps. This adds a significant level of overhead to training. There may be techniques to improve this performance, including leveraging more recurrent network layouts.

After training, we took the output values of the network against a 1,000 input “test” dataset. This dataset comprises a random sample of 1,000 values, selected from a random linear space with a maximum value of 1.0. In FIG. 9, the mean squared error of each network is reported. The 16 LIF Neuron hidden layer network performed worst, as would be expected for a smaller network. The dendritic network and LIF-only SNNs achieved similar performance.

When examining the \sqrt{x} function, the 256 hidden LIF network scored a mean squared error of 2.146e-3. Reducing the size of the hidden to 16 hidden LIF neurons produced a mean squared error of 5.292e-2. Finally, our library's dendrite-LIF network with 16 LIF neurons had a mean squared error of 1.093e-3. With the Mish (x) function, the 256 hidden LIF network achieved a 3.08e-3 mean squared error, and the 16 hidden LIF network achieved a mean squared error of 8.07e-3. The 16 hidden dendrite network achieved an mean squared error of 3.22e-3, slightly worse than the much larger 256 hidden layer network. In general, despite having fewer total signals transmitted from the hidden layer to the output layer, the dendritic network was able to provide a similar error when compared with the SNN. This demonstrates the improved expressivity of SNNs when equipped with dendritic input trees. By simply moving the computation of the LIF neurons into the dendrite, the network is able to achieve accuracy parity with the larger network despite sending only 16 values to the next layer.

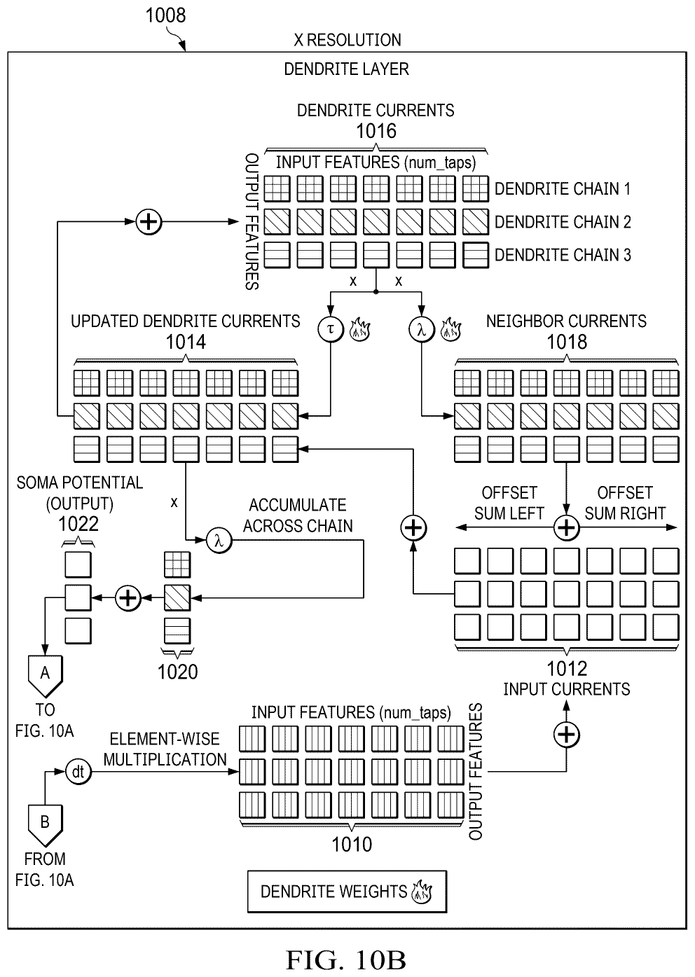

FIG. 10 depicts the operation of a dendrite model in conjunction with a convolutional neural network in accordance with an illustrative embodiment. A residual network (ResNet) is a type of ANN that addresses the problem of vanishing gradients during backpropagation in which updates to a model's parameters to become increasingly small, thereby stalling the learning process, especially in layers closer to the input. ResNets employ residual (skip) connections that bypass one or more layers in the network. Skip connections allow the output of a layer to be added to the output of another layer further along in the network (e.g., in a 10-layer network (not shown) the output of layer 5 can be added to the output of layer 7 as input to layer 8).

A pooling layer may be used in a ResNet to reduce the spatial dimensions of feature maps while retaining the most important information. The pooling layer helps reduce computational complexity, avoid overfitting of the model, and greater abstraction in feature extraction. Pooling layers are typically employed in conjunction with convolutional layers with the network to achieve downsampling. In the example shown in FIGS. 10A and 10B, dendritic pooled ResNet 1000 uses a dendrite layer 1008 in place of a conventional pooling layer.

Convolutional encoder 1002 represents the convolutional encoding layers of dendritic pooled ResNet 1000 leading up to the pooling layer comprising dendrite model 1008. The spatial dimensions of the output tensor 1004 from the last convolutional layer of encoder 1002 is flattened to produce channel inputs 1006. Flattening the spatial dimensions matches the structure of the dendrite chains. Channel inputs 1006 are then fed into the dendrite layer 1008 to produce input features 1010.

Input features vector 1010 are added to input currents 1012 of each dendrite. Each dendrite comprises multiple inputs into different compartments represented by the blocks in each chain shown in FIG. 10. The input currents 1012 are added to whatever value is already present in the respective compartments of each dendrite to produce updated dendrite currents 1014. Dendrite layer 1008 iterates through a prescribed number of loops (x Resolutions) in which communications of dendrite currents 1016 between each compartment within a dendrite chain changes the value of neighbor currents 1018 in adjacent compartment at each time step (loop), which are then added back to the input currents 1012. Communication within a given dendrite chain goes in both directions between compartments.

The rate of that change is determined by applying A and t, wherein A affects cross-compartment communication and t affects how quickly each compartment responds to signals (how quickly a value will increase given a certain input). The number of time steps and the fidelity (amount of time per iteration step) are predefined constants.

After the prescribed number of loops, the values 1020 of the last compartments in each dendrite chain are fed into an output soma 1022. The soma 1022 in turn is connected to classification head 1024, which comprises a standard fully connected layer that detects classes from the input initially fed into convolutional encoder 1002.

The dendrite layer 1008 acts as a pooling layer by taking an N-dimensional input features vector 1010 derived from the convolutional encoder 1002 and outputting multiple scalar values based on the interaction between the compartments of the dendrite chains. The spatial dimension can be reduced to 1, e.g., if the input size is X*Y*I, the output would be X*Y*1.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A dendrite computing network, comprising:
a dendrite comprising a number of dendrite compartments in a sequential chain, wherein each dendrite compartment has a respective state with an electrical current value for a given time step, and wherein each dendrite compartment saves electrical current values computed in previous time steps;
a respective external electrical input current with a respective input weight for each dendrite compartment;
a respective leak weight for each dendrite compartment;
a temporal modifier that determines how quickly each dendrite compartment responds to input signals; and
a spatial signal transmission constant that controls communication between dendrite compartments, wherein the temporal modifier and spatial signal transmission constant are used to create a kernel that iterates through a specified number of time steps to compute a new electrical current value in the state of each dendrite compartment.

2. The dendrite computing network of claim 1, further comprising a spiking neuron soma that receives output from the last dendrite compartment in the sequential chain.

3. The dendrite computing network of claim 2, wherein the dendrite computing network is part of a hidden layer in a spiking neural network.

4. The dendrite computing network of claim 1, further comprising a network layer that receives output from the last dendrite compartment in the sequential chain.

5. The dendrite computing network of claim 1, wherein each dendrite compartment further receives time-delayed inputs from neighboring dendrite compartments in the sequential chain in addition to the external electrical input current.

6. The dendrite computing network of claim 1, wherein the dendrite computing network is part of a pooling layer in a residual network.

7. The dendrite computing network of claim 1, wherein the dendrite compartments comprise passive resistor-capacitor circuits.

8. The dendrite computing network of claim 7, wherein the resistor-capacitor circuits are modeled using CMOS transistors.

9. The dendrite computing network of claim 1, wherein dendrite behavior is modeled according to a machine learning library that maps between the network and hardware devices.

10. A dendrite-enabled spiking neural network, comprising:
an input layer;
a hidden layer comprising a number of dendrite neuron chains, wherein each dendrite neuron chain comprises a dendrite having a number of dendrite compartments in a sequential chain; and
an output layer that receives output signals from the last dendrite compartments in the sequential chains and combines the output signals into a single spiking neuron soma.

11. The dendrite-enabled spiking neural network of claim 10, wherein each dendrite compartment has a respective state with an electrical current value for a given time step, and wherein each dendrite compartment saves electrical current values computed in previous time steps.

12. The dendrite-enabled spiking neural network of claim 10, wherein each dendrite compartment receives time-delayed inputs from neighboring dendrite compartments in the sequential chain in addition to a respective external electrical input current with a respective input weight, and wherein each dendrite compartment has a respective leak weight.

13. The dendrite-enabled spiking neural network of claim 10, wherein a temporal modifier determines how quickly each dendrite compartment within each dendrite responds to input signals.

14. The dendrite-enabled spiking neural network of claim 13, wherein a spatial signal transmission constant controls communication between dendrite compartments.

15. The dendrite-enabled spiking neural network of claim 14, wherein the temporal modifier and spatial signal transmission constant are used to create a kernel that iterates through a specified number of time steps to compute a new electrical current value of each dendrite compartment.

16. A dendrite-enabled residual network, comprising:
a convolutional encoder;
a dendrite pooling layer comprising a number of dendrite neuron chains, wherein each dendrite neuron chain comprises:
a dendrite comprising a number of dendrite compartments in a sequential chain; and
a spiking neuron soma that receives output from the last dendrite compartment in the sequential chain; and
a fully connected classification head that receives output from the dendrite pooling layer.

17. The dendrite-enabled residual network of claim 16, wherein each dendrite compartment has a respective state with an electrical current value for a given time step, and wherein each dendrite compartment saves electrical current values computed in previous time steps.

18. The dendrite-enabled residual network of claim 16, wherein each dendrite compartment receives time-delayed inputs from neighboring dendrite compartments in the sequential chain in addition to a respective external electrical input current with a respective input weight, and wherein each dendrite compartment has a respective leak weight.

19. The dendrite-enabled residual network of claim 16, wherein a temporal modifier determines how quickly each dendrite compartment within each dendrite responds to input signals.

20. The dendrite-enabled residual network of claim 19, wherein a spatial signal transmission constant controls communication between dendrite compartments.

21. The dendrite-enabled residual network of claim 20, wherein the temporal modifier and spatial signal transmission constant are used to create a kernel that iterates through a specified number of time steps to compute a new electrical current value of each dendrite compartment.
